(19) United States
(12) Patent Application Publication
(10) Pub. No.: US 2020/0164519 A1
(43) Pub. Date: May 28, 2020

(54) MOTION CONTROL APPARATUS OF ACTION ROBOT AND MOTION GENERATION AND CONTROL SYSTEM INCLUDING THE SAME

(71) Applicant: LG Electronics Inc., Seoul (KR)

(72) Inventors: Sangmin LEE, Seoul (KR); Sanghun KIM, Seoul (KR); Daeun Park, Seoul (KR)

(21) Appl. No.: 16/690,670

(22) Filed: Nov. 21, 2019

(30) Foreign Application Priority Data
Nov. 22, 2018 (KR) 10-2018-0145568

(51) Int. Cl. B25J 9/16; G06F 3/16; B25J 17/02

(52) U.S. Cl. CPC B25J 9/1694; B25J 17/02; G06F 3/165

(57) ABSTRACT

Disclosed herein is a motion control apparatus of an action robot including an audio playback controller configured to process sound data and control output of a speaker to play back sound corresponding to the sound data based on a result of processing, and a processor configured to acquire motion data corresponding to music, generate a motion control command based on the acquired motion data, and convert the generated motion control command according to a protocol corresponding to an action robot to be controlled.

### CROSS-REFERENCE TO RELATED APPLICATION

This application claims priority under 35 U.S.C. § 119 and 35 U.S.C. § 365 to Korean Application No. 10-2018-0145568 filed on Nov. 22, 2018, whose entire disclosure is hereby incorporated by reference.

### BACKGROUND

### 1. Field

The present disclosure relates to a motion control apparatus of an action robot and, more particularly, to a motion control apparatus capable of motion control with respect to various types of action robots or simulators and a motion generation and control system including the same.

### 2. Background

As robot technology has been developed, methods of constructing a robot by modularizing joints or wheels have been used. For example, a plurality of actuator modules configuring the robot is electrically and mechanically connected and assembled, thereby manufacturing various types of robots such as dogs, dinosaurs, humans, spiders, etc.

A robot which may be manufactured by assembling the plurality of actuator modules is generally referred to as a modular robot. Each actuator module configuring the modular robot has a motor provided therein, such that motion of the robot is executed according to rotation of the motor. Motion of the robot includes action of a robot such as action and dance.

Recently, as entertainment robots come to the front, interest in robots for inducing human interest or entertainment has been increasing. For example, technology for allowing a robot to dance to music has been developed.

The robot can dance, by presetting a plurality of motions corresponding to music and executing the preset motions when an external device plays music.

However, in the related art, an interface for generating motion data with respect to a variety of music cannot be provided and the robot may dance using only motion data corresponding to some music provided by a manufacturer.

In addition, conventionally, since there is only a dedicated motion control apparatus or a motion control tool for each robot, it is necessary to provide a motion control tool or a motion control apparatus which can be universally used for various types of robots or robot simulators.

### BRIEF DESCRIPTION OF THE DRAWINGS

The embodiments will be described in detail with reference to the following drawings in which like reference numerals refer to like elements wherein:

FIG. 1 is a schematic block diagram of a motion generation and control system of an action robot according to an embodiment of the present disclosure.

FIG. 2 is a block diagram showing an example of the control configuration of the motion generation apparatus shown in FIG. 1.

FIG. 3 is a block diagram showing an example of the control configuration of the motion control apparatus shown in FIG. 1.

FIG. 4 is a flowchart illustrating operation of the motion generation apparatus shown in FIG. 1.

FIG. 5 is a view showing operation of components included in the motion generation apparatus according to the embodiment of FIG. 4.

FIG. 6 is a view showing a motion setting screen provided by a motion data generator of a motion generation apparatus.

FIG. 7 is a flowchart illustrating motion control operation when the motion control apparatus shown in FIG. 1 is implemented in an action robot.

FIG. 8 is a view showing an example related to motion control operation of the motion control apparatus shown in FIG. 7.

FIG. 9 is a flowchart illustrating motion control operation when the motion control apparatus shown in FIG. 1 includes a robot simulator.

FIG. 10 is a view showing an example related to motion control operation of the motion control apparatus shown in FIG. 9.

FIG. 11 is a view showing an example of an action robot implemented on the action robot or robot simulator of FIG. 1 and output through a display.

### DETAILED DESCRIPTION

Description will now be given in detail according to exemplary embodiments disclosed herein, with reference to the accompanying drawings. The accompanying drawings are used to help easily understand the embodiments disclosed in this specification and it should be understood that the embodiments presented herein are not limited by the accompanying drawings. As such, the present disclosure should be construed to extend to any alterations, equivalents and substitutes in addition to those which are particularly set out in the accompanying drawings.

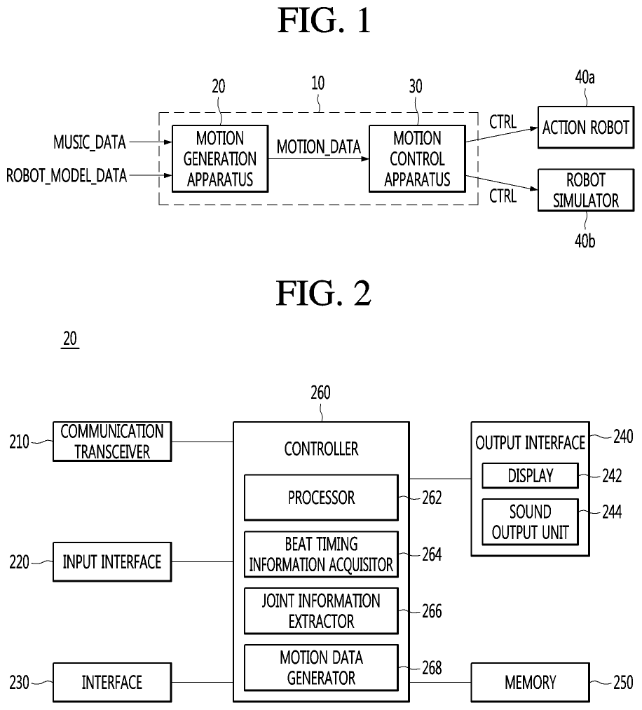

FIG. 1 is a schematic block diagram of a motion generation and control system of an action robot according to an embodiment of the present disclosure.

The action robot refers to a robot for controlling movement of at least one joint through a robot driver having an actuator module including a plurality of motors and performing operation such as dance or motion. In some embodiments, the action robot may include an action robot implemented on a robot simulator included in a computing apparatus (a PC, etc.). The robot simulator may output the action robot in a graphic form through a display of the computing apparatus.

Referring to FIG. 1, a motion generation and control system 10 may include a motion generation apparatus 20 and a motion control apparatus 30.

The motion generation apparatus 20 and the motion control apparatus 30 may be implemented as various apparatuses. For example, the motion generation apparatus 20 and the motion control apparatus 30 may be integrally implemented in a computing apparatus (e.g., a PC, etc.) or may be integrally implemented in an action robot.

In some embodiments, the motion generation apparatus 20 and the motion control apparatus 30 may be implemented as separate apparatuses. For example, the motion generation apparatus 20 may be implemented in a computing apparatus (a PC, etc.) and the motion control apparatus 30 may be implemented in an action robot.

The motion generation apparatus 20 may include a motion generation software module for generating motion data MOTION_DATA of motion to be performed by the action robot in correspondence with music data, using model data ROBOT_MODEL_DATA including joint information of the action robot and music data MUSIC_DATA.

Meanwhile, the music data MUSIC_DATA described in this specification is for convenience of description and the embodiment of the present disclosure is similarly applicable to sound data corresponding to various types of sounds in addition to the music data.

The motion control apparatus 30 may include a motion control software module for generating a motion control command for performing control such that the action robot performs motion set with respect to a specific playback time point of music corresponding to the music data MUSIC_DATA, based on the motion data MOTION_DATA generated by the motion generation apparatus 20. The motion control apparatus 30 may perform control CTRL of an action robot 40a or a robot simulator 40b using the generated motion control command.

In particular, the motion control software module included in the motion control apparatus 30 may convert the generated motion control command according to a protocol corresponding to the type of the action robot 40a or the robot simulator 40b to be controlled. Therefore, the motion control apparatus 30 can control various types of action robots or robot simulators.

FIG. 2 is a block diagram showing an example of the control configuration of the motion generation apparatus shown in FIG. 1.

The motion generation apparatus 20 of FIG. 2 may correspond to a computing apparatus (a PC, etc.) or an action robot. Such a motion generation apparatus 20 may generate motion data MOTION_DATA using a motion generation software module, as described above with reference to FIG. 1.

The motion generation apparatus 20 may include a communication interface 210, an input interface 220, an interface 230, an output interface 240, a memory 250 and a controller 260. The components shown in FIG. 2 are examples for convenience of description, and the motion generation apparatus 20 may include more or fewer components than those shown in FIG. 2.

The communication interface 210 may include at least one communication module for connecting the motion generation apparatus 20 to a server or a terminal through a network. For example, the communication interface 210 may include a short-range communication module such as Bluetooth or a near field communication (NFC), a wireless Internet module such as Wi-Fi, and a mobile communication module such as LTE (long term evolution).

The motion generation apparatus 20 may receive the music data MUSIC_DATA and the robot model data ROBOT_MODEL_DATA described above with reference to FIG. 1 from the server or the terminal connected through the communication interface 210.

In addition, if the motion generation apparatus 20 and the motion control apparatus 30 are implemented as different apparatuses, the communication interface 210 may transmit the generated motion data MOTION_DATA from the motion generation apparatus 20 to the motion control apparatus 30.

The input interface 220 may include at least one input part for inputting a predetermined signal or data to the motion generation apparatus 20 by operation or the other action of a user. For example, the at least one input part may include a button, a dial, a touchpad, a microphone, etc. The user may input a request or a command to the motion generation apparatus 20, by operating the button, the dial and/or the touchpad.

The interface 230 serves as an interface with various types of external apparatuses connected to the motion generation apparatus 20. Such an interface 230 may include a wired/wireless data port, a memory card port, a video port, a connection port with an external device (a mouse, a keyboard, etc.), etc. In particular, when the input device is connected with the motion generation apparatus 20 through the interface 230, the input device may perform a function similar to the input interface 220.

In some embodiments, when the motion generation apparatus 20 and the motion control apparatus 30 are connected through the interface 230, a processor 262 may transmit the motion data MOTION_DATA to the motion control apparatus 30 through the interface 230.

The output interface 240 may output a variety of information related to operation or state of the motion generation apparatus 20 or various services, programs, applications, etc. executed on the motion generation apparatus 20. In addition, the output interface 240 may output various types of messages or information for performing interaction with the user of the motion generation apparatus 20.

For example, the output interface 240 includes a display 242 and a sound output unit 244.

The display 242 may output the various types of information or messages in the graphic form. In some embodiments, the display 242 may be implemented in the form of a touchscreen including a touchpad. In this case, the display 242 may perform not only an output function but also an input function.

The sound output unit 244 may output the various types of information or messages in the form of voice. For example, the sound output unit 244 may include at least one speaker.

In the memory 250, a variety of information such as control data for controlling operation of the components included in the motion generation apparatus 20, data for performing operation corresponding to input acquired through the input interface 220, etc. may be stored.

In addition, program data of the motion generation software module may be stored in the memory 250. The processor 262 of the controller 260 may execute the motion generation software module based on the program data.

In addition, the music data MUSIC_DATA and/or the robot model data ROBOT_MODEL_DATA may be stored in the memory 250. The music data MUSIC_DATA and/or the robot model data ROBOT_MODEL_DATA may be received and stored from an external apparatus through the communication interface 210 or the interface 230, without being limited thereto. When the motion data MOTION_DATA is generated by the motion generation software module, the memory 250 may store the generated motion data MOTION_DATA.

The memory 250 may be various storage devices such as a ROM, a RAM, an EPROM, a flash drive, a hard drive, etc. in hardware.

The controller 260 may include at least one processor or controller for controlling operation of the motion generation apparatus 20. Specifically, the controller 260 may include at least one CPU, application processor (AP), microcomputer, integrated circuit, application specific integrated circuit (ASIC), etc.

For example, the processor 262 included in the controller 260 may control overall operation of the components included in the motion generation apparatus 20.

In particular, as the program data of the motion generation software module stored in the memory 250 is loaded, the processor 262 may execute the motion generation software module. The processor 262 may acquire the motion data MOTION_DATA through the executed motion generation software module. Operation of the configurations 264, 266 and 268 included in the motion generation software module may be controlled by the processor 262 or another processor or controller included in the controller 260.

The motion generation software module may generate the motion data MOTION_DATA based on the music data MUSIC_DATA and the robot model data ROBOT_MODEL_DATA.

For example, the motion generation software module may include a beat timing information acquisitor 264, a joint information extractor 266 and a motion data generator 268. In some embodiments, each of the beat timing information acquisitor 264, the joint information extractor 266, and the motion data generator 268 is implemented by a combination of hardware and software.

The beat timing information acquisitor 264 may acquire beat timing information of music corresponding to the music data MUSIC_DATA, based on a repetition pattern of a specific sound source, a generation period of particular sound, etc. from the music data MUSIC_DATA. To this end, the beat timing information acquisitor 264 may acquire the beat timing information using various known beat tracking algorithms. In general, since dance or action related to music is performed in units of bits of music, the motion generation apparatus 20 may acquire beat timing information of the music data MUSIC_DATA, thereby generating the motion data MOTION_DATA.

Meanwhile, the music data MUSIC_DATA may be implemented in an audio file format such as an MP3 (MPEG-1 Audio Layer-3) format.

The joint information extractor 266 may extract joint information of the action robot from the robot model data ROBOT_MODEL_DATA.

The robot model data ROBOT_MODEL_DATA may include a variety of information related to the action robot (or the action robot implemented on the robot simulator). For example, the robot model data ROBOT_MODEL_DATA may include joint information of at least one joint included in the action robot. The joint information may include information on the name, location, movable range (e.g., a rotation angle, etc.) of at least one joint. The robot model data ROBOT_MODEL_DATA may be implemented in a file format such as a simulation description format (SDF), without being limited thereto.

In some embodiments, the joint information extractor 266 may further extract, from the robot model data ROBOT_MODEL_DATA, message format definition information for providing a control command in a data format capable of being recognized and processed by the action robot (or the robot simulator). The message format definition information include information on a class or function necessary to generate a control command for controlling the rotation angle of each joint, information related to the data format of the control command, etc. That is, the message format definition information may be changed according to the type of the action robot (or the robot simulator).

The motion data generator 268 may generate the motion data MOTION_DATA corresponding to the music data MUSIC_DATA, from the beat timing information acquired by the beat timing information acquisitor 264 and the joint information extracted by the joint information extractor 266.

For example, the motion data generator 268 may display a motion setting screen for generating the motion data MOTION_DATA corresponding to the music data MUSIC_DATA through the display 242. The motion data generator 268 may acquire motion information set with respect to at least one of the beat timings of the music data MUSIC_DATA, based on the displayed motion setting screen. For example, the user may input motion information for the bit timings of the music data MUSIC_DATA through the input interface 220. The motion information may include rotation angle information of at least one joint included in the joint information.

The motion data generator 268 may generate the motion data MOTION_DATA including the acquired motion information. For example, the motion data MOTION_DATA may be generated in a JSON (JavaScript Object Notation) file format or an XML (eXtensible Markup Language) file format, without being limited thereto.

The generated motion data MOTION_DATA may be stored in the memory 250 or may be transmitted to the motion control apparatus 30 through the communication interface 210.

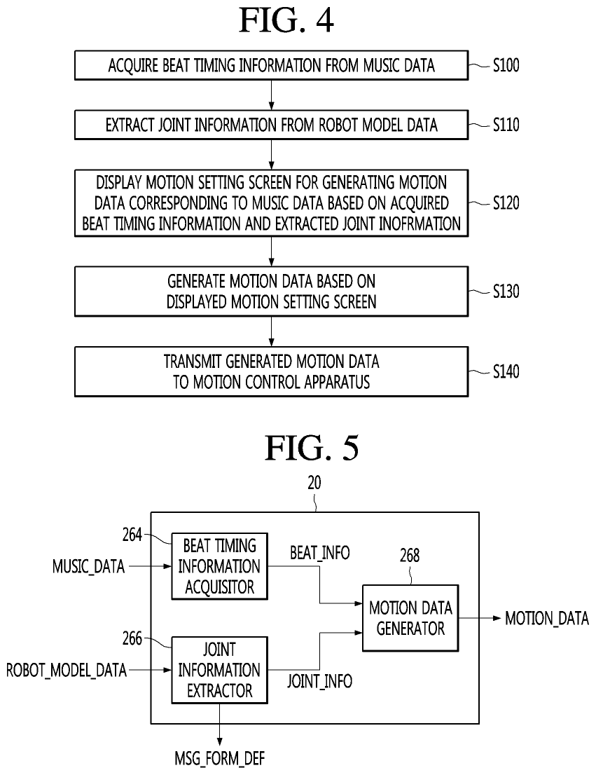

Operation of the motion generation apparatus 20 will be described in detail below with reference to FIGS. 4 to 6.

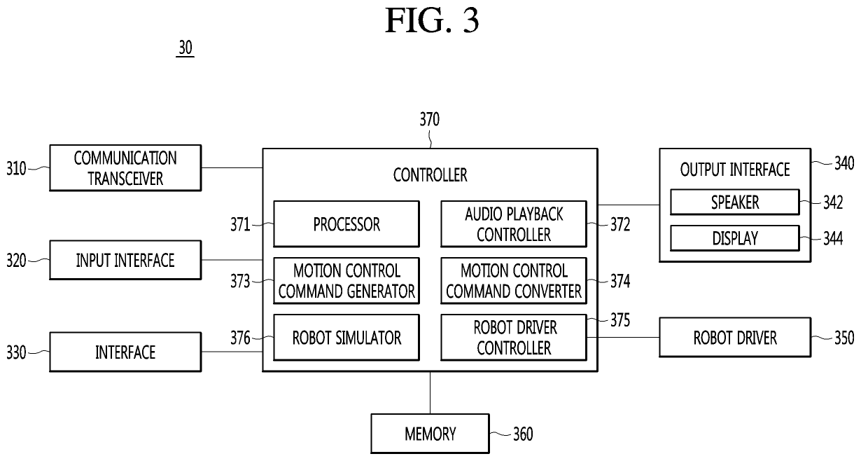

FIG. 3 is a block diagram showing an example of the control configuration of the motion control apparatus shown in FIG. 1.

The motion control apparatus 30 of FIG. 3 may correspond to a computing apparatus (a PC, etc.) or an action robot. As described above, the motion control apparatus 30 may be implemented as the same apparatus as the motion generation apparatus 20 or may be implemented as a separate apparatus. The motion control apparatus 30 may generate a motion control command using a motion control software module.

Referring to FIG. 3, the motion control apparatus 30 may include a communication interface 310, an input interface 320, an interface 330, an output interface 340, a memory 360 and a controller 370. The components shown in FIG. 3 are examples for convenience of description and the motion control apparatus 30 may include more or fewer components than those shown in FIG. 3.

The communication interface 310 may include at least one communication module for connecting the motion control apparatus 30 to a server or a terminal through a network. For example, the communication interface 310 may include a short-range communication module such as Bluetooth or a near field communication (NFC), a wireless Internet module such as Wi-Fi, and a mobile communication module such as LTE (long term evolution).

The motion control apparatus 30 may receive the music data MUSIC_DATA from the server or the terminal connected through the communication interface 310.

In addition, if the motion generation apparatus 20 and the motion control apparatus 30 are implemented as different apparatuses, the communication interface 310 may receive the motion data MOTION_DATA and message format definition information from the motion generation apparatus 20.

In addition, when the motion control apparatus 30 is connected to the action robot 40a or the robot simulator 40b through the communication interface 310, the processor 371 may control the communication interface 310 to transmit a motion control command to the action robot 40a or the robot simulator 40b.

The input interface 320 may include at least one input part for inputting a predetermined signal or data to the motion control apparatus 30 by operation or the other action of a user. For example, the at least one input part may include a button, a dial, a touchpad, a microphone, etc. The user may input a request or a command to the motion control apparatus 30, by operating the button, the dial and/or the touchpad.

The interface 330 serves as an interface with various types of external apparatuses connected to the motion control apparatus 30. Such an interface 330 may include a wired/wireless data port, a memory card port, a video port, a connection port with an external device (a mouse, a keyboard, etc.), etc. In particular, when the input device is connected with the motion control apparatus 30 through the interface 330, the input device may perform a function similar to the input interface 320.

In some embodiments, when the motion control apparatus 30 is connected to the motion generation apparatus 20 through the interface 330, the motion control apparatus 30 may receive the motion data MOTION_DATA from the motion generation apparatus 20 through the interface 330.

The output interface 340 may output a variety of information related to operation or state of the motion control apparatus 30 or various services, programs, applications, etc. executed on the motion control apparatus 30. In addition, the output interface 240 may output various types of messages or information for performing interaction with the user of the motion control apparatus 30.

For example, the output interface 340 may include at least one of a speaker 342 or a display 344.

The speaker 342 may output the above-described variety of information or messages in the form of voice or sound. In particular, a audio playback controller 372 included in the controller 370 may control output of the speaker 342 in order to play music corresponding to the music data MUSIC_DATA through the speaker 342.

The display 344 may output the above-described variety of information or messages in the graphic form. In some embodiments, the display 344 may be implemented in the form of a touchscreen including a touchpad. In this case, the display 344 may perform not only an output function but also an input function.

In the memory 360, a variety of information such as control data for controlling operation of the components included in the motion control apparatus 30, data for performing operation corresponding to input acquired through the input interface 320, etc. may be stored.

In addition, program data of the motion control software model may be stored in the memory 360. The processor 371 of the controller 370 may execute the motion control software module based on the program data.

The memory 360 may be various storage devices such as a ROM, a RAM, an EPROM, a flash drive, a hard drive, etc. in hardware.

The controller 370 may include at least one processor or controller for controlling operation of the motion control apparatus 30. Specifically, the controller 370 may include at least one CPU, application processor (AP), microcomputer, integrated circuit, application specific integrated circuit (ASIC), etc.

For example, the processor 371 included in the controller 370 may control overall operation of the components included in the motion control apparatus 30.

In particular, as the program data of the motion control software module stored in the memory 360 is loaded, the processor 371 may execute the motion control software module. The processor 371 may acquire a motion control command for controlling a robot driver 350 or a robot simulator 376 through the executed motion control software module. Alternatively, the processor 371 may acquire a motion control command for control of the action robot 40a or the robot simulator 40b connected to the motion control apparatus 30 through the motion control software module.

Operation of the configurations 373 and 374 included in the motion control software module may be controlled by the processor 371 or another processor or controller included in the controller 370.

The audio playback controller 372 may control output of the speaker 342, in order to play back music, etc. based on sound data such as the music data MUSIC_DATA. For example, the audio playback controller 372 may execute a playback program capable of processing the music data MUSIC_DATA and play back music corresponding to the music data MUSIC_DATA through the executed playback program.

The motion control software module may generate a motion control command for controlling motion of the action robot based on the motion data MOTION_DATA and the music data MUSIC_DATA.

For example, the motion control software module may include a motion control command generator 373 and a motion control command converter 374. In some embodiments, each of the motion control command generator 373 and the motion control command converter 374 is implemented by a combination of hardware and software.

The motion control command generator 373 may generate a motion control command for controlling motion of the action robot using the motion data MOTION_DATA provided by the motion generation apparatus 20.

Meanwhile, as described above with reference to FIG. 2, the motion data MOTION_DATA includes motion information set with respect to at least one of the beat timings of the music data MUSIC_DATA. The motion control command generator 373 may generate a motion control command using motion information set with respect to the beat timings of the playback time point at a specific playback time point of music and provide the generated motion control command to the motion control command converter 374.

That is, the motion control command generator 373 should generate a motion control command synchronized to the playback time point of music output through the audio playback controller 372 and the speaker 342. Therefore, the action robot may perform motion corresponding to the playback time point of the music.

To this end, the motion control command generator 373 may synchronize a time point (beat timing) in the motion data MOTION_DATA with a playback time point (beat timing) of the music (or the music data MUSIC_DATA) through the synchronization process with the audio playback controller 372.

In some embodiments, the motion control command generator 373 may generate a plurality of motion control commands in advance based on the motion information of each of beat timings included in the motion data MOTION_DATA. The motion control command generator 373 may sequentially provide the motion control command converter 374 with the motion control information corresponding to a predetermined playback time point (beat timing, etc.) of the music (or the music data MUSIC_DATA) among a plurality of motion control commands through the synchronization process with the audio playback controller 372.

Meanwhile, the motion control command generator 373 may generate the motion control command based on the motion data MOTION_DATA and the message format definition information. The message format definition information may include a class, a function, etc. related to at least one joint to be controlled through the motion control command. That is, the motion control command generator 373 may generate a motion control command including commands capable of being recognized and processed by the action robot based on the message format definition information.

The motion control command may be generated in a JSON file format an XML file format similarly to the motion data MOTION_DATA, without being limited thereto.

The motion control command converter 374 may convert the motion control command generated by the motion control command generator 373 according to a communication protocol supported by the action robot (or the robot simulator) to be controlled. To this end, information on the communication protocol supported by the action robot to be controlled may be stored in the memory 360 of the motion control apparatus 30.

For example, the motion control command converter 374 may convert the motion control command in the JSON or XML file format into a packet format of a byte array in order to provide the motion control command to the action robot through a universal asynchronous receiver/transmitter (UART). Alternatively, the motion control command converter 374 convert the motion control command in the JSON or XML file format into a message format of a message transport protocol having a publish/subscribe (pub/sub) structure.

Meanwhile, if the motion control apparatus 30 is implemented as the action robot 40a, the motion control apparatus 30 may include a robot driver 350 and a robot driver controller 375.

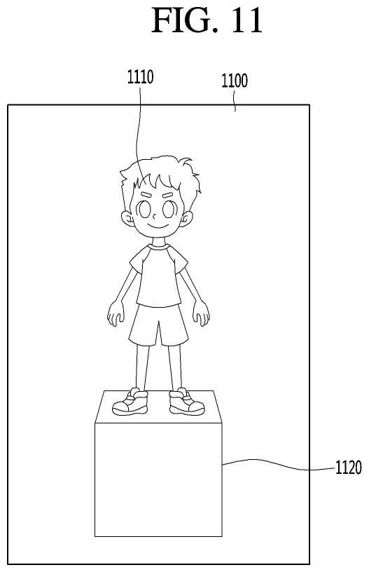

The robot driver 350 may include an actuator module including a plurality of motors. The plurality of motors included in the robot driver 350 may correspond to respective joints formed in a robot module 1110 (see FIG. 11) of the action robot. When one or two or more of the plurality of motors are driven, joints corresponding thereto may rotate.

Meanwhile, the robot driver 350 may be connected with various types of robot modules 1110. In this case, the location or number of joints may vary according to the type of the robot module 1110. The robot driver controller 375 may acquire information on the robot module 1110 connected to the robot driver 350 and control the robot driver 350 based on the acquired information, thereby enabling motion control of the various types of robot modules 1110.

The robot driver controller 375 may control the robot driver 350 based on the motion control command provided by the motion control command converter 374.

Meanwhile, if the motion control apparatus 30 includes a robot simulator 376, the motion control apparatus 30 may not include the robot driver 350 and the robot driver controller 375. In this case, the robot simulator 376 may control movement of joins included in the action robot implemented on the robot simulator based on the motion control command provided by the motion control command converter 374.

The embodiments related to operation of the motion control apparatus 30 will be described in greater detail with reference to FIGS. 7 to 11.

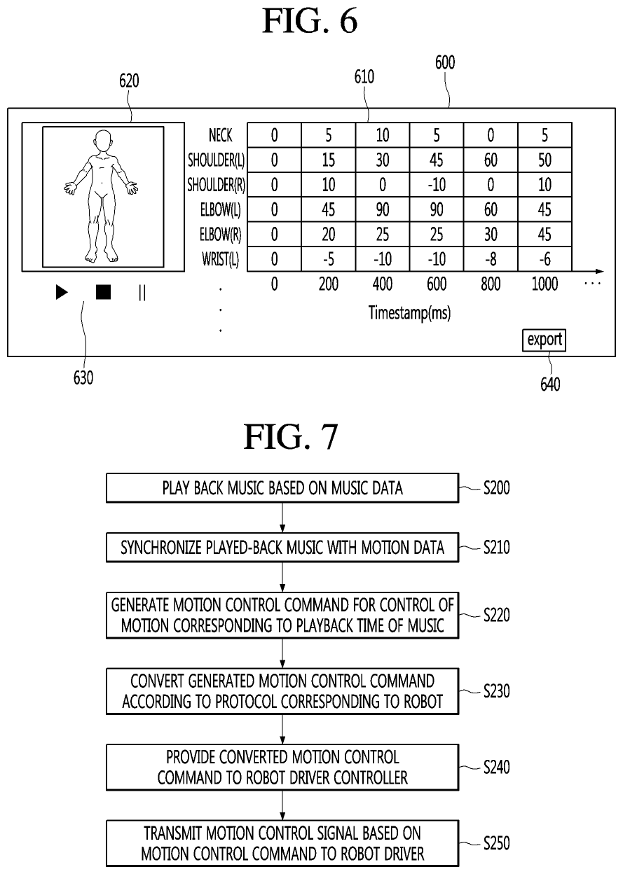

FIG. 4 is a flowchart illustrating operation of the motion generation apparatus shown in FIG. 1. FIG. 5 is a view showing operation of components included in the motion generation apparatus according to the embodiment of FIG. 4. FIG. 6 is a view showing a motion setting screen provided by a motion data generator of a motion generation apparatus.

Referring to FIGS. 4 and 5, the motion generation apparatus 20 may acquire beat timing information BEAT_INFO (timing information) from the music data MUSIC_DATA (sound data) (S100).

The beat timing information acquisitor 264 of the motion generation apparatus 20 may acquire beat timing information BEAT_INFO from the music data MUSIC_DATA provided by the communication interface 210, the interface 230 or the memory 250.

As described above with reference to FIG. 2, the beat timing information acquisitor 264 may acquire the beat timing information BEAT_INFO from the music data MUSIC_DATA using a known beat tracking algorithm.

The motion generation apparatus 20 may extract joint information JOINT_INFO from the robot model data ROBOT_MODEL_DATA (S110).

The joint information extractor 266 may extract the joint information JOINT_INFO including the name, location, controllable rotation angle information of at least one joint among a variety of information related to the action robot included in the robot model data ROBOT_MODEL_DATA

In some embodiments, the joint information extractor 266 may acquire the message format definition information MSG_FORM_DEF from the robot model data ROBOT_MODEL_DATA. The message format definition information may include a data format for generating a control command capable of being recognized and processed by the action robot or information on a class or a function for controlling the rotation angle of each joint.

The message format definition information MSG_FORM_DEF may be stored in the memory 250, and may be transmitted to the motion control apparatus 30 along with the motion data MOTION_DATA through the communication interface 210 or the interface 230.

The motion generation apparatus 20 may display a motion setting screen for generating the motion data MOTION_DATA corresponding to the music data MUSIC_DATA through the display 242, based on the acquired beat timing information BEAT_INFO and the extracted joint information JOINT INFO (S120). The motion generation apparatus 20 may generate the motion data MOTION_DATA including input motion information based on the displayed motion setting screen (S130). The motion generation apparatus 20 may transmit the generated motion data MOTION_DATA to the motion control apparatus 30 (S140).

The motion data generator 268 may provide the motion setting screen for generating the motion data MOTION_DATA. The processor 262 may control the display 242 to display the motion setting screen.

The motion data generator 268 may generate the motion data MOTION_DATA based on information input and set through the displayed motion setting screen. The generated motion data MOTION_DATA may be stored in the memory 250 and may be transmitted to the motion control apparatus 30 through the communication interface 210 or the interface 230.

In some embodiments, the motion data generator 268 may combine the motion data MOTION_DATA and the music data MUSIC_DATA into one file.

Hereinafter, an example of the motion setting screen provided by the motion data generator 268 will be described with reference to FIG. 6.

Referring to FIG. 6, the motion setting screen 600 may include a motion data input window 610, a simulation window 620, a simulation control menu 630 and a motion data generation item 640.

The motion setting screen 600 may include the motion data input window 610 for inputting and setting the rotation angles of the joints included in the joint information JOINT_INFO, with respect to each of a plurality of timestamps based on the beat timing information BEAT_INFO acquired from the music data MUSIC_DATA.

The motion data generator 268 may define the plurality of timestamps based on time information of each of the beat timings from the beat timing information BEAT_INFO acquired by the beat timing information acquisitor 264.

The motion data generator 268 may generate the motion data input window 610 in the form of a table shown in FIG. 6, using the name and movable range of each of the joints included in the joint information JOINT_INFO extracted from the joint information extractor 266 and the plurality of timestamps.

For example, a first axis (e.g., a horizontal axis) of the motion data input window 610 may sequentially indicate the plurality of timestamps and a second axis (e.g., a vertical axis) may indicate the plurality of joints.

The processor 262 may receive information on the rotation angle of each joint for each timestamp based on the motion data input window 610 from the user through the input interface 220, and display the received information on the motion data input window 610. In some embodiments, if the rotation angle of a particular joint, which is the input information, exceeds a movable range, the processor 262 may modify the rotation angle of the particular joint to a rotation angle corresponding to a maximum movable range and display the modified rotation angle on the motion data input window 610 or inform the user that the rotation angle exceeds the maximum movable range through the output interface 240.

The motion data generator 268 may include the simulation window 620 representing the action robot and a graphic image reflecting the joint locations of the action robot, based on the name and location of each of the joints included in the joint information JOINT INFO.

In addition, when a playback request is received through the simulation control menu 630, the motion data generator 268 may provide a simulation function reflecting the information input to the motion data input window 610 through the simulation window 620. That is, the motion data generator 268 may change and display the graphic image of the action robot to represent the action robot with elapse of time, using the information of the rotation angle of each of the joints for each timestamp input to the motion data input window 610.

When the user selects the motion data generation item 640, the motion data generator 268 may generate the motion data MOTION_DATA including information on the rotation angle of each of the joints for each timestamp input to the motion data input window 610.

That is, according to the embodiments shown in FIGS. 4 to 6, the motion generation apparatus 20 may provide an interface capable of generating the motion data MOTION_DATA using the beat timing information BEAT_INFO of the music data MUSIC_DATA and the joint information JOINT_INFO of the action robot. Therefore, the user can freely and conveniently generate the motion data MOTION_DATA of the action robot through the interface.

In particular, the motion generation apparatus 20 may extract the joint information JOINT INFO from the model data ROBOT_MODEL_DATA of the action robot to be controlled, thereby being universally used to generate the motion data MOTION_DATA of various action robots.

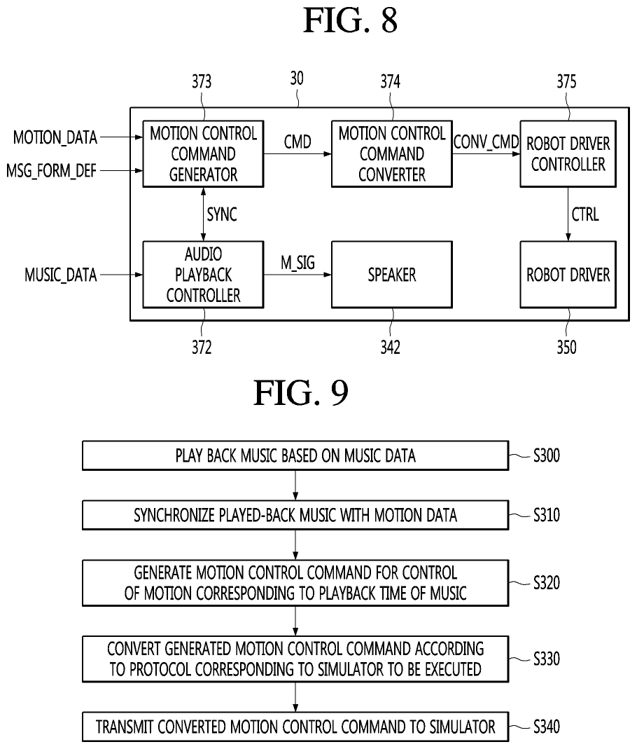

FIG. 7 is a flowchart illustrating motion control operation when the motion control apparatus shown in FIG. 1 is implemented in an action robot. FIG. 8 is a view showing an example related to motion control operation of the motion control apparatus shown in FIG. 7.

FIGS. 7 and 8 show an embodiment in which the motion control apparatus 30 is implemented as the action robot 40a, that is, the motion control software module is implemented in the action robot 40a.

Referring to FIGS. 7 and 8, the motion control apparatus 30 may play back music based on the music data MUSIC_DATA (S200), and perform synchronization between the played-back music and the motion data MOTION_DATA (S210).

The audio playback controller 372 may receive the playback request of the music corresponding to the music data MUSIC_DATA. The music data MUSIC_DATA may be stored in the memory 360 along with the motion data MOTION_DATA or may be received through the motion generation apparatus 20 or the communication interface 310 when or after the playback request is received (e.g., a streaming method, etc.).

For example, the motion generation apparatus 20 may combine the music data MUSIC_DATA and the motion data MOTION_DATA into one file and transmit the file to the motion control apparatus 30.

Alternatively, the motion generation apparatus 20 may transmit only the motion data MOTION_DATA to the motion control apparatus 30. At this time, information on the music data MUSIC_DATA or a music name corresponding to the motion data MOTION_DATA may be included.

The audio playback controller 372 may transmit an output signal M_SIG based on the music data MUSIC_DATA to the speaker 342, in order to output music through the speaker 342. For example, the output signal M_SIG may correspond to a digital signal including the music data MUSIC_DATA. The speaker 342 may convert the output signal M_SIG into an analog signal to output the music.

Meanwhile, when the playback request of the music is received, the motion control command generator 373 may acquire the motion data MOTION_DATA corresponding to the music. For example, the motion control command generator 373 may load the motion data MOTION_DATA corresponding to the music among a plurality of motion data stored in the memory 360, in response to the playback request. Alternatively, the motion control command generator 373 may receive, from, the motion generation apparatus 20, the motion data MOTION_DATA from the motion generation apparatus 20 when or after the playback request is received.

The motion control command generator 373 and the audio playback controller 372 may synchronize the motion of the action robot according to the acquired motion data MOTION_DATA with the music. If a provider who provides the music data MUSIC_DATA to the motion generation apparatus 20 and a provider who provides the music data MUSIC_DATA to the motion control apparatus 30 are different from each other, time points when first sound is output at the time of playing back both the music data MUSIC_DATA may be different from each other. In this case, the motion and the music may be out of sync.

Therefore, the motion control command generator 373 and the audio playback controller 372 may synchronize the motion data MOTION_DATA with the music data MUSIC_DATA such that motion of the action robot for a particular timestamp is performed in correspondence with a music playback time point corresponding to the timestamp.

The motion control apparatus 30 may generate a motion control command CMD for performing control to perform motion corresponding to the playback time point of the music output by the action robot, based on the result of synchronization (S220).

The motion control command generator 373 may generate motion control commands including rotation angle information (motion information) of the joints for each timestamp in the motion data MOTION_DATA. Each motion control command may include motion information for any one timestamp.

For example, the motion control command generator 373 may sequentially generate motion control commands CMD according to elapse of the playback time of the music and sequentially provide the motion control commands to the motion control command converter 374. Alternatively, the motion control command generator 373 may generate a plurality of motion control commands respectively corresponding to the plurality of timestamps included in the motion data MOTION_DATA and sequentially provide the plurality of generated motion control commands to the motion control command converter 374 in correspondence with the playback time of the music.

The motion control command generator 373 may generate the motion control command CMD including the motion information based on the message format definition information MSG_FORM_DEF provided by the motion generation apparatus 20. For example, the motion control command generator 373 may generate the motion control command CMD based on the data format defined to be recognized and processed by the robot driver controller 375 or information on a class or function for each of the joints included in the message format definition information MSG_FORM_DEF.

The motion control command generator 373 may provide the generated motion control command CMD to the motion control command converter 374.

The motion control apparatus 30 may convert the generated motion control command according to a protocol corresponding to the action robot (S230), and provide the converted motion control command to the robot driver controller 375 (S240).

The motion control command converter 374 may convert the motion control command CMD provided by the motion control command generator 373 according to a protocol corresponding to the robot driver controller 375.

For example, when the robot driver controller 375 performs UART communication with the processor 371 or another controller, the motion control command converter 374 may convert the motion control command in a JSON or XML file format into a packet format of a byte array capable of being processed by the robot driver controller 375.

The motion control command converter 374 may transmit the converted motion control command CONV_CMD to the robot driver controller 375.

Although not shown, if the motion control apparatus 30 is implemented to be connected to the action robot 40a through the communication interface 310 or the interface 330 and various types of the action robots are capable of being connected with the motion control apparatus 30, the motion control apparatus 30 may store protocol information of each of the various types of action robots in the memory 360. The motion control command converter 374 may acquire corresponding protocol information from the memory 360 based on information on the action robot connected to the motion control apparatus 30, and convert the motion control command CMD according to the acquired protocol information. The motion control command converter 374 may transmit the converted motion control command CMD to the action robot through the communication interface 310 or the interface 330.

The motion control apparatus 30 may control motion of the action robot, by transmitting the motion control signal based on the motion control command to the robot driver 350 (S250).

The robot driver controller 375 may generate a motion control signal CTRL for controlling the robot driver 350 based on the received motion control command CONV_CMD, and transmit the generated motion control signal CTRL to the robot driver 350.

For example, the motion control signal CTRL may correspond to a signal for controlling driving of at least one of the plurality of motors included in the robot driver 350. That is, the robot driver controller 375 may determine at least one motor to be driven among the plurality of motors and the driving value of the at least one motor from the received motion control command CONV_CMD and generate the motion control signal CTRL based thereon.

The at least one of the plurality of motors included in the robot driver 350 may be driven based on the motion control signal CTRL. As the at least one motor is driven, motion of the action robot may be performed.

Steps S220 to S250 may be repeatedly performed in correspondence with the number of pieces of motion information included in the motion data MOTION_DATA when the music is played back. Therefore, the action robot may provide action (dance) through the plurality of motions performed while the music is performed, thereby arousing user's interest.

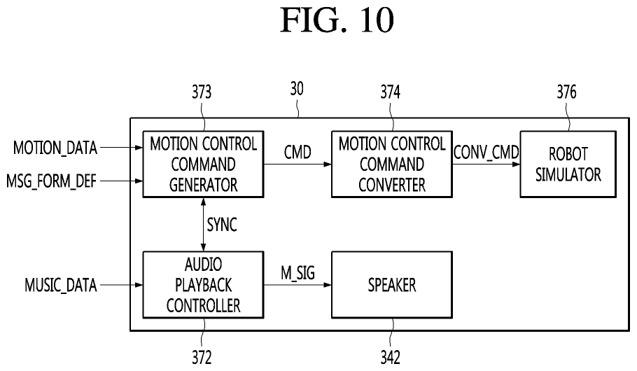

FIG. 9 is a flowchart illustrating motion control operation when the motion control apparatus shown in FIG. 1 includes a robot simulator. FIG. 10 is a view showing an example related to motion control operation of the motion control apparatus shown in FIG. 9.

FIGS. 9 and 10 show an embodiment in which the motion control apparatus 30 is implemented integrally with the robot simulator or the motion control apparatus 30 and the robot simulator 376 are included in the computing apparatus.

Referring to FIGS. 9 and 10, steps S300 to S320 are substantially equal to steps S200 to S220 of FIG. 7 and thus a description thereof will be omitted.

The motion control apparatus 30 may convert the motion control command generated in step S320 according to a protocol corresponding to the robot simulator 376 to be executed (S330), and transmit the converted motion control command to the robot simulator 376 (S340).

Similarly to step S230, the motion control command converter 374 may convert the motion control command CMD provided by the motion control command generator 373 according to the protocol (or the message format) corresponding to the robot simulator 376.

Although not shown, a plurality of robot simulators may be implemented in the motion control apparatus 30 or the motion control apparatus 30 and the plurality of robot simulators may be connected. In this case, the motion control apparatus 30 may store the protocol information of each of the plurality of robot simulators in the memory 360. The motion control command converter 374 may acquire corresponding protocol information from the memory 360 based on information on a currently executed robot simulator or a robot simulator connected to the motion control apparatus 30, and convert the motion control command CMD according to the acquired protocol information.

The motion control command converter 374 may transmit the converted motion control command CONV_CMD to the robot simulator 376.

The robot simulator 376 may control motion of the action robot implemented on the simulator based on the received motion control command CONV_CMD, and display the changed graphic image of the action robot through the display 344 according to motion control.

That is, according to the embodiments shown in FIGS. 7 to 10, the motion control apparatus 30 may generate motion control information in correspondence with the action robot or the robot simulator to be controlled, and convert the motion control information based on the protocol of the action robot or the robot simulator to be controlled. Therefore, the motion control apparatus 30 may be universally used for motion control of various types of action robots and robot simulators.

In addition, the motion control apparatus 30 may synchronize the played-back sound (or sound content) with motion, thereby providing motion synchronized with the played-back sound even if different sound data corresponding to the same sound is provided.

FIG. 11 is a view showing an example of an action robot implemented on the action robot or robot simulator of FIG. 1 and output through a display.

Referring to FIG. 11, the action robot may include a robot module 1110 and a main body 1120.

The robot module 1110 may have a human shape, an animal shape or a character shape thereof. In the robot module 1110, a plurality of joints may be implemented. The plurality of joints implemented in the robot module 1110 may be connected with the robot driver 350 provided in the main body 1120 through wires or links. In some embodiments, the motor of the robot driver 350 may be provided in each of the plurality of joints.

The main body 1120 may include the robot driver 350 and the robot driver controller 375. In some embodiments, the main body 1120 may further include the speaker 342 and the audio playback controller 372 for playback of sound. That is, the action robot may simultaneously perform a music playback function and an action function.

In some embodiments, the motion control apparatus 30 may be further implemented in the main body 1120. That is, the main body 1120 may be implemented as a computing apparatus including at least some of the components described above with reference to FIG. 3. The action robot may receive, from the motion generation apparatus 20, the motion data MOTION_DATA and the message format definition information MSG_FORM_DEF, and perform playback of music and action according to motion of the robot module 1110 based on the received motion data MOTION_DATA, the message format definition information MSG_FORM_DEF and the music data MUSIC_DATA.

In some embodiments, when the action robot is implemented on the robot simulator 40b, the robot simulator 40b may display a simulation screen 1100 including the action robot 1110 in the form of a graphic image through the display.

The robot simulator 40b can provide action by changing and displaying motion of the action robot implemented as the graphic image based on the motion control information CONY CMD generated and converted by the motion control apparatus 30 as described above with respect to FIGS. 9 to 10.

According to the embodiments of the present invention, a motion control apparatus and a motion control software module included therein may generate motion control information in correspondence with an action robot or robot simulator to be controlled, and convert the motion control information based on a protocol of the action robot or robot simulator to be controlled. That is, the motion control apparatus and the motion control software module may be universally used for motion control of various types of action robots and robot simulators.

In addition, the motion control apparatus and the motion control software module can provide motion synchronized with played-back sound even if different sound data corresponding to the same sound is provided, by performing synchronization between the played-back sound and motion.

In addition, the motion generation apparatus included in the motion generation and control system may provide an interface capable of generating motion data using timing information of sound data and joint information of an action robot. Therefore, a user can freely and conveniently generate motion data of the action robot through the interface.

In addition, the motion generation apparatus can extract joint information from model data of an action robot to be controlled, thereby being universally used to generate motion data of various action robots.

The foregoing description is merely illustrative of the technical idea of the present invention, and various changes and modifications may be made by those skilled in the art without departing from the essential characteristics of the present invention.

Therefore, the embodiments disclosed in the present invention are to be construed as illustrative and not restrictive, and the scope of the technical idea of the present invention is not limited by these embodiments.

The scope of the present invention should be construed according to the following claims, and all technical ideas within equivalency range of the appended claims should be construed as being included in the scope of the present invention.

An object of the present disclosure is to provide a motion control apparatus which can be universally used for an action robot implemented on various types of action robots or robot simulators.

Another object of the present disclosure is to provide a motion generation and control system for providing an interface for generating motion data of an action robot for audio corresponding to audio data, using audio data and joint information of the action robot.

According to an embodiment, a motion control apparatus of an action robot includes an audio playback controller configured to process audio data and control output of a speaker to play back audio corresponding to the audio data based on the processing of the audio data, and a processor configured to obtain motion data corresponding to the audio, provide a motion control command based on the acquired motion data, and convert the motion control command based on a protocol corresponding to a specific action robot to be controlled, the specific action robot includes at least one joint.

The motion data may include motion information corresponding to at least one timestamp of the audio, and the motion information may include rotation angle information of the at least one joint of the specific action robot.

The processor may provide a first motion control command corresponding to a first timestamp based on the motion information of the at least one timestamp.

In some embodiments, the processor may provide the motion control command based on the motion information and message format definition information of the specific action robot, and the message format definition information may include information on a class or function for control of the at least one joint of the specific action robot and information on a data format the motion control command.

In some embodiments, the processor may synchronize the audio data with the motion data such that motion of the action robot based on the motion information is performed at a playback time of the audio corresponding to the at least one timestamp.

In some embodiments, the motion control apparatus may further include at least one motor configured to rotate the at least one joint included in the specific action robot and a robot driver controller configured to control the at least one motor based on the converted motion control command.

In some embodiments, the motion control apparatus may further include a main body including the audio playback controller, the speaker, the processor, the at least one motor and the robot driver controller and the robot module connected to the at least one motor.

In some embodiments, the motion control apparatus may further include a communication transceiver or an interface connected to the specific action robot, and the processor may transmit the converted motion control command to the specific action robot through the communication transceiver or the interface.

In some embodiments, the motion control apparatus may further include a display, and a robot simulator configured to display, on the display, the specific action robot as a graphic image and to display motion of the specific action robot based on the converted motion control command.

According to another embodiment, a motion generation and control system of an action robot includes a motion generation apparatus including a first processor configured to obtain timing information from audio data and provide motion data corresponding to the audio data based on joint information of at least one joint of a specific action robot and the timing information, an audio playback controller configured to process audio data and control output of a speaker to play back audio corresponding to the audio data based on the processing of the audio data, and a motion control apparatus including a second processor configured to provide a motion control command based on the motion data and convert the motion control command according to a protocol corresponding to the specific action robot.

In some embodiments, the first processor is configured to extract the joint information from robot model data of the specific action robot, and the joint information may include at least one of identification information, and a location and movable range information of the at least one joint of the specific action robot.

The first processor may provide message format definition information based on the robot model data.

In some embodiments, the motion generation apparatus includes a display, and the first processor may display, on the display, a motion setting screen for setting motion information of a plurality of timestamps based on the timing information, based on the timing information and the joint information.

The first processor may provide the motion data including motion information of each of the plurality of timestamps set based on the motion setting screen and provide the motion data to the motion control apparatus.

In some embodiments, the second processor may synchronize the audio data with the motion data such that motion of the action robot based on motion information of each of the timestamps of the motion data is performed at a playback time of the audio corresponding to the at least one timestamp.

In some embodiments, the first processor may combine the audio data and the motion data into one file.

In some embodiments, the motion generation apparatus is connected to the motion control apparatus through a communication transceiver or an interface such that the motion generation apparatus to transmit the motion data to the motion control apparatus through the communication transceiver or the interface.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A motion control apparatus of an action robot, comprising:
an audio playback controller configured to process audio data and control output of a speaker to play back audio corresponding to the audio data based the processing of the audio data; and
a processor configured to:
obtain motion data corresponding to the audio,
provide a motion control command based on the acquired motion data, and
convert the motion control command based on a protocol corresponding to a specific action robot to be controlled, the specific action robot includes at least one joint.

2. The motion control apparatus of claim 1,
wherein the motion data includes motion information corresponding to at least one timestamp of the audio, and
wherein the motion information includes rotation angle information of the at least one joint of the specific action robot.

3. The motion control apparatus of claim 2, wherein the processor is configured to provide a first motion control command corresponding to a first timestamp based on the motion information of the at least one timestamp.

4. The motion control apparatus of claim 2,
wherein the processor is configured to provide the motion control command based on the motion information and message format definition information of the specific action robot, and
wherein the message format definition information includes information on a class or function for control of the at least one joint of the specific action robot and information on a data format for the motion control command.

5. The motion control apparatus of claim 2, wherein the processor is configured to synchronize the audio data with the motion data such that motion of the action robot based on the motion information is performed at a playback time of the audio corresponding to the at least one timestamp.

6. The motion control apparatus of claim 1, further comprising:
at least one motor configured to rotate the at least one joint in a robot module of the specific action robot; and
a robot driver controller configured to control the at least one motor based on the converted motion control command.

7. The motion control apparatus of claim 6, further comprising:
a main body including the audio playback controller, the speaker, the processor, the at least one motor and the robot driver controller; and
the robot module connected to the at least one motor.

8. The motion control apparatus of claim 1, further comprising a communication transceiver or an interface connected to the specific action robot,
wherein the processor is configured to transmit the converted motion control command to the specific action robot through the communication transceiver or the interface.

9. The motion control apparatus of claim 1, further comprising:
a display; and
a robot simulator configured to display, on the display, the specific action robot as a graphic image and to display motion of the specific action robot based on the converted motion control command.

10. A motion generation and control system of an action robot, comprising:
a motion generation apparatus including a first processor configured to obtain timing information from audio data and provide motion data corresponding to the audio data based on joint information of at least one joint of the specific action robot and the timing information;
an audio playback controller configured to process audio data and control output of a speaker to play back audio corresponding to the audio data based on the processing of the audio data; and
a motion control apparatus including a second processor configured to provide a motion control command based on the motion data and convert the motion control command according to a protocol corresponding to the specific action robot.

11. The motion generation and control system of claim 10,
wherein the first processor is configured to extract the joint information from robot model data of the specific action robot, and
wherein the joint information includes at least one of identification information, and a location and movable range information of the at least one joint of the specific action robot.

12. The motion generation and control system of claim 11,
wherein the first processor is configured to provide message format definition information based on the robot model data, and
wherein the message format definition information includes information on a class or function for control of the at least one joint of the specific action robot and information on a data format for the motion control command.

13. The motion generation and control system of claim 10,
wherein the motion generation apparatus includes a display,
wherein the first processor is configured to display, on the display, a motion setting screen for setting motion information of a plurality of timestamps based on the timing information, based on the timing information and the joint information, and
wherein the motion information includes rotation angle information of the at least one joint of the specific action robot.

14. The motion generation and control system of claim 13, wherein the first processor is configured to provide the motion data including motion information of each of the plurality of timestamps set based on the motion setting screen and to provide the motion data to the motion control apparatus.

15. The motion generation and control system of claim 14, wherein the second processor is configured to synchronize the audio data with the motion data such that motion of the action robot based on motion information of each of the timestamps of the motion data is performed at a playback time of the audio corresponding to the at least one timestamp.

16. The motion generation and control system of claim 10, wherein the first processor is configured to combine the audio data and the motion data into one file.

17. The motion generation and control system of claim 10, wherein the motion generation apparatus is connected to the motion control apparatus through a communication transceiver or an interface such that the motion generation apparatus to transmit the motion data to the motion control apparatus through the communication transceiver or the interface.

18. The motion generation and control system of claim 10, further comprising a memory configured to store the motion data.

19. The motion generation and control system of claim 10, further comprising:
at least one motor configured to rotate the at least one joint in a robot module of the specific action robot; and
a robot driver controller configured to control the at least one motor based on the converted motion control command.

20. The motion generation and control system of claim 10, further comprising:
a display; and
a robot simulator configured to display, on the display, the action robot implemented as a graphic image and to display motion of the action robot based on the converted motion control command.
